(19) United States
(12) Patent Application Publication
(10) Pub. No.: US 2025/0314362 A1
(43) Pub. Date: Oct. 9, 2025

(54) Multifunctional Outdoor Solar Stake Light and Electrical Projector System

(71) Applicant: Violet Patterson, Miami, FL (US)

(72) Inventor: Violet Patterson, Miami, FL (US)

(21) Appl. No.: 19/173,204

(22) Filed: Apr. 8, 2025

Related U.S. Application Data
(60) Provisional application No. 63/631,486, filed on Apr. 9, 2024.

(51) Int. Cl. F21S 9/03; F21V 21/08; F21V 23/04; F21Y 115/10

(52) U.S. Cl. CPC F21S 9/03; F21V 21/0824; F21V 23/0435; F21V 23/0442; F21Y 2115/10

(57) ABSTRACT

An outdoor lighting and projection system that includes a light fixture device and a projector device is disclosed. The light fixture device comprises a display device integrated with a yard stake and a solar panel for absorbing solar power (i.e., solar energy) to illuminate the display. The projector device features a projector system pivotally coupled to a first arm and a second arm via hinge (i.e., pivotal) brackets, enabling for tilting, panning, and ground installation. An internal memory includes premade slides and messages for display by the display device and projection by the projector system. The system includes a wireless module for remote control via a mobile application and an AC to DC adaptor for external power supply. The system is configured for remote operation and provides different projection and illumination.

### CROSS-REFERENCE TO RELATED APPLICATION

The present application claims priority to, and the benefit of, U.S. Provisional Application No. 63/631,486, which was filed on Apr. 9, 2024, and is incorporated herein by reference in its entirety.

### FIELD OF THE INVENTION

The present invention generally relates to the field of projection devices and illumination devices. More specifically, the present invention relates to a multifunctional outdoor solar stake light and electrical projector system. The system includes a solar-powered light on a single-yard stake and a projector device. The system includes premade slides and/or messages which can be displayed by the light device and projected by the projector device. The system includes a remote control or a software application to control the lights and projector. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals like to communicate effectively with their neighbors and community members. However, communication and conveying messages without engaging in face-to-face conversations is difficult. Lack of communication with neighbors can lead to a sense of isolation or missed opportunities for meaningful interaction within the community.

Also, many individuals enjoy decorating their home exteriors for seasonal purposes or to celebrate special occasions. They like to display special messages or signs on exterior walls of their buildings but often lack efficient means to do so. Lawns, gardens, and other outdoor areas often lack adequate lighting, particularly during evening hours, which can pose safety concerns or diminish the enjoyment of outdoor spaces. Traditional outdoor lighting systems require time-consuming installations and multiple fixtures to sufficiently illuminate a property, which may not be feasible for busy individuals or those with limited technical skills. Furthermore, individuals often seek creative and unique ways to decorate their homes, especially for holidays, events, or personal celebrations. However, existing solutions do not offer the flexibility or versatility desired for such decorations. Individuals desire an improved lighting and projection system that overcomes the problems associated with displaying messages and illuminating outdoor areas.

Therefore, there exists a long-felt need in the art for an improved outdoor lighting and projection system. There is also a long-felt need in the art for a multifunctional outdoor lighting and projection system that offers a platform for communication and decorative displays. Additionally, there is a long-felt need in the art for an illumination and projection device that can project custom slides and messages onto a surface such as the wall of a building. Moreover, there is a long-felt need in the art for an improved illumination device that is easy to install and operate and offers a way for individuals to display phrases, seasonal images, and the like. Further, there is a long-felt need in the art of an outdoor lighting and projection system that enables individuals to display messages and provide illumination. Furthermore, there is a long-felt need in the art for an improved projection device that can be remotely operated by a user. Finally, there is a long-felt need in the art for a novel system that combines solar-powered lighting, projection capabilities, and remote-controlled customization for any home or business owner.

The subject matter disclosed and claimed herein, in one embodiment thereof, comprises an outdoor lighting and projection system. The system features a light fixture device which includes an LED display device and a yard stake for fixing the light fixture device in the ground, the display device is integrated to a top end of the yard stake. At least one solar panel is slidably attached to the yard stake for absorbing solar power (i.e., solar energy) and converting it into electrical power for illuminating the display. A projector device includes a projector system for projecting messages or signs on a surface such as the wall of a building. A wireless module is included in the system for enabling a remote user to operate and configure the outdoor lighting and projection system using a mobile application. Customized messages can be transmitted from the mobile application for projection on the wall from the projector system.

In this manner, the outdoor lighting and projection system of the present invention accomplishes all of the foregoing objectives and provides users with a system that combines both illumination and projection capabilities. The system can light up their outdoor spaces while also displaying messages, images, or decorations, enhancing the overall functionality of the system. The system harnesses solar energy making the system environmentally friendly and cost-effective. The projector device offers both vertical tilt and horizontal pan adjustments, enabling users to direct projections precisely where desired. The system can be controlled remotely via a mobile application, providing users with convenience and flexibility. The system provides a unique platform for communicating with neighbors or community members by displaying messages or images.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an outdoor lighting and projection system. The system further comprises a light fixture device which includes a display device and a yard stake for fixing the light fixture device in the ground, the display device is integrated to a top end of the yard stake. At least one solar panel is slidably attached to the yard stake for absorbing solar power (i.e., solar energy) and converting it into electrical power for illuminating the display. A projector device includes a projector system for projecting messages or signs. A wireless module is included in the system for enabling a remote user to operate and configure the outdoor lighting and projection system using a mobile application.

In yet another embodiment, an outdoor lighting and projection system is disclosed. The system includes a display and a yard stake for fixing the light fixture device in the ground, the display is integrated to a top end of the yard stake. At least one solar panel slidably attached to the yard stake for absorbing solar power (i.e., solar energy) and converting it into electrical power for illuminating the display and a projection system. An internal memory is disposed in the display, the internal memory includes premade slides and messages for displaying on the display and projecting by the projector system. An internal battery stores electric power generated by at least one solar panel and a light sensor automatically/autonomously adjusts the brightness of the projector system based on ambient light conditions.

In another embodiment, a projector device for outdoor use is disclosed. The projector device includes a projector system pivotally coupled to a first arm via a hinge bracket, wherein the projector system is configured to tilt vertically and panning horizontally, a second arm is pivotally hinged to the first arm for fixing the projector device in the ground, a projection lens, a light sensor that automatically/autonomously adjusts the brightness of the projector system based on ambient light conditions, an internal memory including premade slides and messages for projecting by the projector system and an AC to DC adaptor for converting received AC supply to DC supply.

Preferably, the projector device features a projector system pivotally coupled to a first arm via a hinge bracket, enabling for tilting and panning, and a second arm for ground installation.

In another aspect, a method for projecting and illuminating using an outdoor lighting and projection system is disclosed. The method includes installing a light fixture device and a projector device in the ground at an appropriate location, wirelessly coupling the outdoor lighting and projection system to a user device for enabling remote operation and configuration, activating the light fixture device using a solar panel and activating the projector device using either the solar panel or an external electric power supply, and projecting a message through a projection system of the projector device, and displaying a message on a display of the light fixture device, wherein the messages can be the same or different.

The system of the present invention can be used for communication purposes. Users can display phrases or other indicia to interact with neighbors or community members, making it a fun and engaging way to share messages. The projector can be used to display themed images or messages for special events such as holidays, birthdays, or celebrations.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the outdoor stake light and electrical projector system of the present invention in accordance with the disclosed structure;

FIG. 2 illustrates a schematic view of the outdoor stake light and electrical projector system of the present invention showing internal electronic components in accordance with the disclosed structure;

FIG. 3 illustrates a schematic view of the connection of the outdoor stake light and electrical projector system and a user device for remote monitoring of the system in accordance with the disclosed architecture;

FIG. 4 illustrates a perspective view showing the projection and messaging system of the present invention in an active state in accordance with the disclosed structure;

FIG. 5 illustrates a perspective view showing projection of a sign by the projector device of the projection and messaging system of the present invention in accordance with the disclosed structure; and

FIG. 6 illustrates a flow chart depicting a process of projection and illumination using the outdoor stake light and electrical projector system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved outdoor lighting and projection system. There is also a long-felt need in the art for a multifunctional outdoor lighting and projection system that offers a platform for communication and decorative displays. Additionally, there is a long-felt need in the art for an illumination and projection device that can project custom slides and messages onto a surface such as the wall of a building. Moreover, there is a long-felt need in the art for an improved illumination device that is easy to install and operate and offers a way for individuals to display phrases, seasonal images, and the like. Further, there is a long-felt need in the art of an outdoor lighting and projection system that enables individuals to display messages and provide illumination. Furthermore, there is a long-felt need in the art for an improved projection device that can be remotely operated by a user. Finally, there is a long-felt need in the art for a novel system that combines solar-powered lighting, projection capabilities, and remote-controlled customization for any home or business owner.

The present invention, in one exemplary embodiment, is an outdoor lighting and projection system. The system includes a display device and a yard stake for fixing the light fixture device in the ground. A solar panel is slidably attached to the yard stake for absorbing solar power (i.e., solar energy) and converting it into electrical power for illuminating the display and a projection system. An internal memory is disposed in the display, the internal memory includes premade slides and messages for displaying on the display and projecting by the projector system. An internal battery stores electric power generated by at least one solar panel and a light sensor automatically/autonomously adjusts the brightness of the projector system based on ambient light conditions.

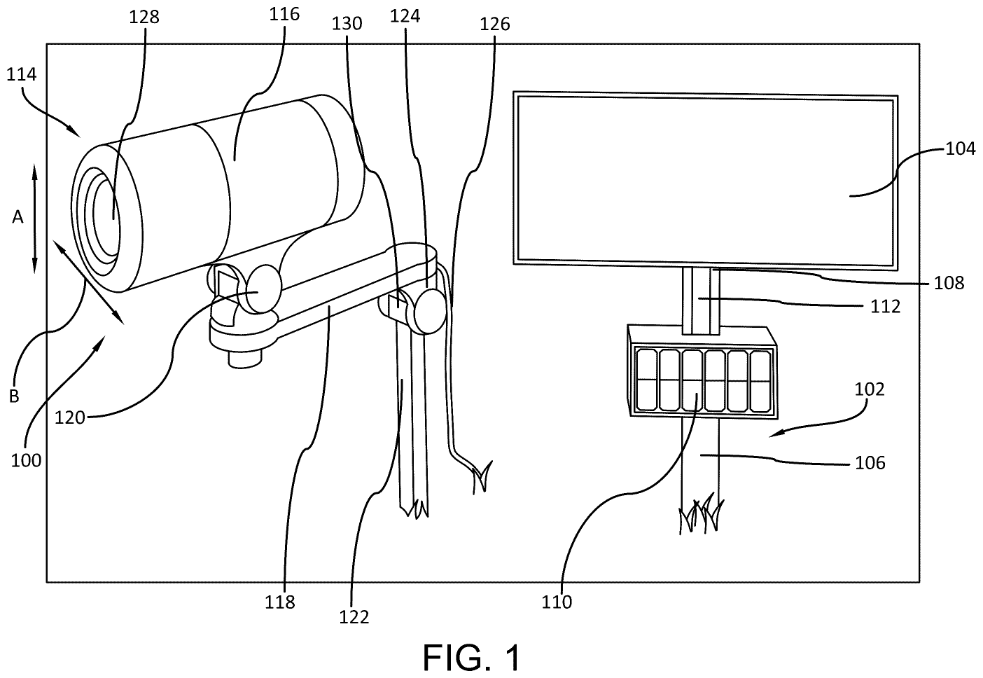

Referring initially to the drawings, FIG. 1 illustrates a perspective view of the outdoor stake light and electrical projector system of the present invention in accordance with the disclosed structure. The outdoor stake light and electrical projector system 100 is designed as an outdoor lighting and projection system designed for different settings such as homes, businesses, and more. The system 100 includes a light fixture device 102 which comprises a display device 104 and a yard stake 106 for fixing the light fixture device 102 in the ground such as the yard. The display device 104 is integrated to the top end 108 of the yard stake 106. At least one solar panel 110 is slidably attached to the yard stake 106 for absorbing solar power (i.e., solar energy) and converting it into electrical power. The converted electrical power is used for providing electricity to the display 104 for displaying a message and for illuminating nearby areas.

The display 104 is preferably an LED display but can be of any conventional display technology. Further, the display 104 can be of any geometric shape and is adapted to rotate 360 degrees either manually or automatically/autonomously to display (i.e., direct) a display message in the desired direction. The display 104 is internally coupled to the solar panel 110 using a wire 112 which passes internally through the stake 106.

The system 100 also includes a projector device 114 adapted to project images, messages, or other content onto surfaces like the side of a home, garage, or any desired area. The projector device 114 includes a projector system 116 pivotally coupled to a first arm 118 via a hinge bracket 120. The projector system 116 can tilt (Arrow A) which includes vertically up or down adjustment of the projector system 116 and panning (Arrow B) to rotate horizontally. Tilt can be useful for adjusting the height of the projection on a surface, which could be useful for aligning the projector device 114 to match the height of a window or a specific part of a wall. Panning can be helpful when aiming the projector at different parts of a house or garden, enabling for wider coverage. A second arm 122 is pivotally hinged to the first arm 118 and is adapted to be fixed to the ground. The first arm 118 can rotate relative to the top end or second hinge bracket 124 of the second arm 122 for providing a desired orientation of the projection through the projector system 116.

In the preferred embodiment, the projector device 114 is solar-powered using the solar panel 110. The projector device 114 is preferably connected to the solar panel 110 of the system 100. The projector device 114 can also be powered using an external electrical supply via an electrical cord 126. The electrical cord 126 can be connected to any conventional power supply such as a wall mounted supply. The projector system 116 works on DC supply as described later in the disclosure.

The system 100 is made of weatherproof and durable materials such as heavy-duty plastic, steel, and more. Further, the projector system 116 is modular and the projection lens 128 can be interchanged to meet the requirements of different users. The projector device 114 also includes a light sensor 130 that automatically/autonomously adjusts the brightness of the projector system 116 based on ambient light conditions to improve visibility and energy efficiency.

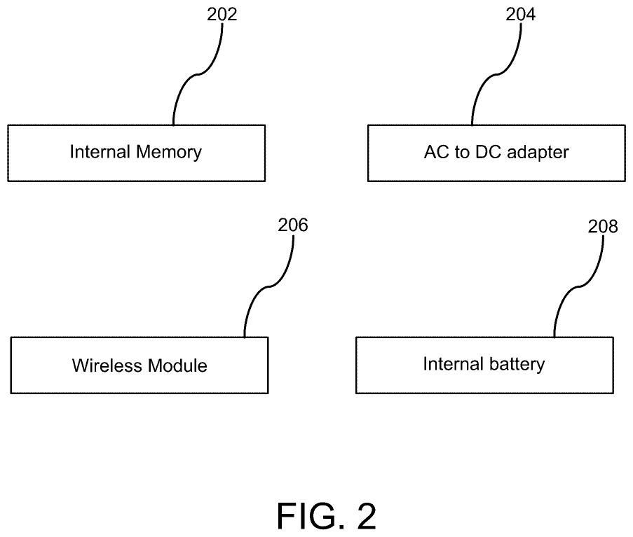

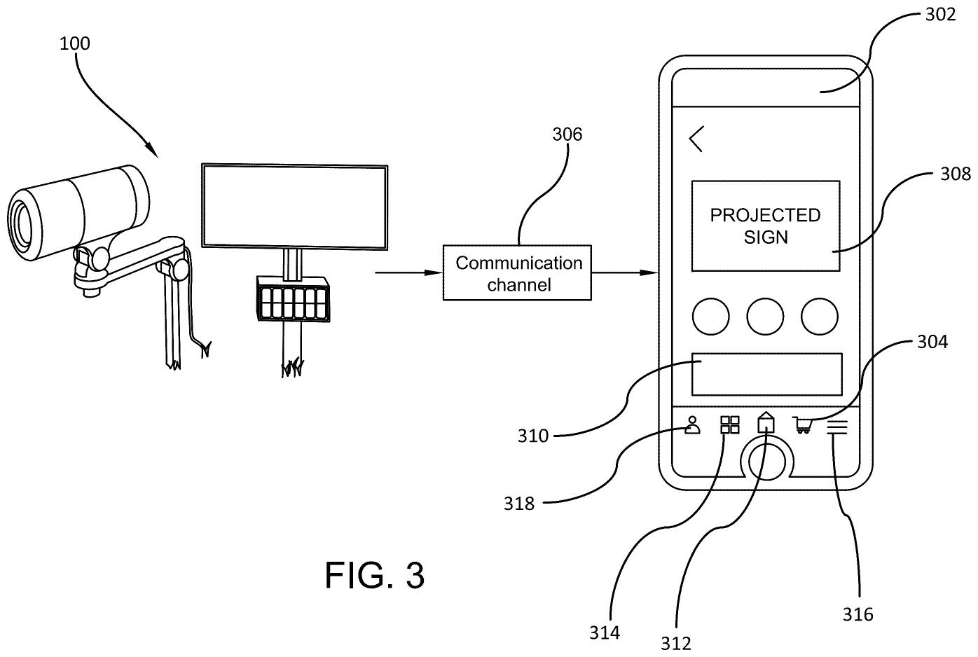

FIG. 2 illustrates a schematic view of the outdoor stake light and electrical projector system of the present invention showing internal electronic components in accordance with the disclosed structure. As illustrated, the system 100 includes an internal memory 202 which is preferably disposed in the display 104. The internal memory 202 includes premade slides and messages which can be used for displaying on the display 104 and projected by the projection device 114. The internal memory 202 can be any type of volatile or non-volatile memory and the premade slides and messages can be updated by a user using a mobile application as described in FIG. 3.

An AC to DC adapter 204 is disposed in the projector device 114. The AC to DC adaptor 204 is adapted to convert the received AC supply from the external electrical supply to the DC supply. The DC supply is used for providing electrical power for functioning of the projector system 116. A wireless module 206 is disposed in the system 100 for coupling the display 104 to a mobile application installed in a user device. The wireless module 206 enables a remote user to operate and configure the system 100 for effective illumination and projection.

An internal battery 208 stores the electric power generated by the at least one solar panel 110. The internal battery 208 provides the necessary electrical power to the display 104 and the projection device 114 for illumination and projection without supply of any external electric power.

FIG. 3 illustrates a schematic view of the connection of the outdoor stake light and electrical projector system and a user device for remote monitoring of the system in accordance with the disclosed architecture. As illustrated, the system 100 through the wireless module 206 is coupled to a user device 302 which includes a mobile application 304 adapted to control and configure the projector device 114 and the display 104. The user device 302 is preferably coupled using the Bluetooth channel 306 but can be done using any conventional long-range or short-range communication channel. The user device 302 can be any electronic computing device such as a smartphone, tablet, laptop, and more.

The application 304 provides an interface 308 which can receive a message 310 in a text box 312. The received message is projected by the projector system 116 on a surface such as the wall of a building. In some embodiments, the projector system 116 can also implement holographic technology for 3D projections. An upload button 314 on the interface 308 enables a user to select an image for projection using the projector system 116. A power option 316 enables remote activation and deactivation of the system 100, thereby eliminating a user to be in physical proximity to the system for operating the system 100. A personalization button 318 enables users to customize the color and duration of the projection and display of the message by the system 100. A customized remote control device can also be used for controlling and operating the system 110 and the control device can provide the same functionality as offered by the mobile application 304.

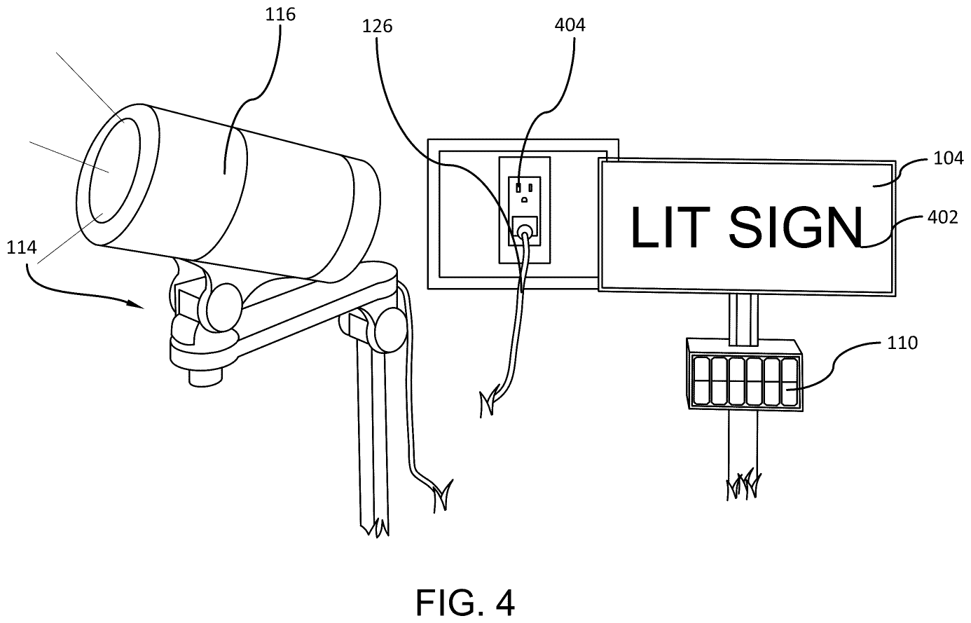

FIG. 4 illustrates a perspective view showing the projection and messaging system of the present invention in an active state in accordance with the disclosed structure. As illustrated, the display 104 in the active state displays a message 402 which can be a preconfigured message or a real time message transmitted from the mobile application 304. The display 104 is powered by the solar panel 110 and can display in a single color or multiple colors to meet requirements of different users.

In the present embodiment, the projector device 114 is powered using the external power supply 404. The direction of the projection system 116 can be oriented in a desired direction for effective projection. A message projected by the projection system 116 can be same or different from the message displayed by the display device 104. The projector device 114 and the light fixture device 102 can be operated simultaneously or independently.

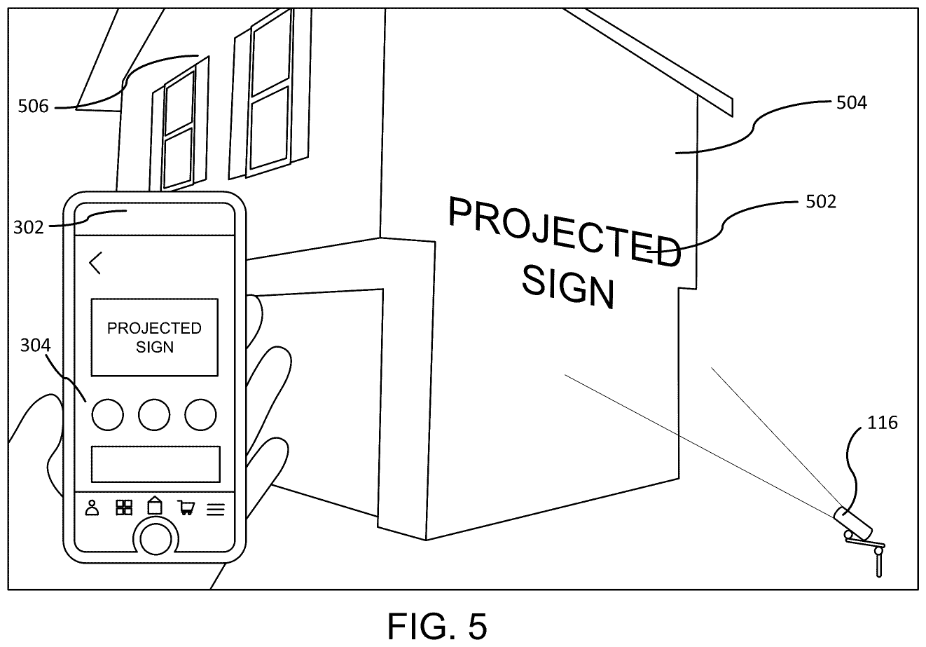

FIG. 5 illustrates a perspective view showing projection of a sign by the projector device of the projection and messaging system of the present invention in accordance with the disclosed structure. The projector device 114 is adapted to project a message 502 on a surface 504 such as the wall of a building 506. The projection system 116 can be adjusted to effectively orient the message 502 on the wall 504. The message or sign 502 can be stored in the internal memory 202 of the system 100 and preferably is input from the mobile application 304 as described in FIG. 3.

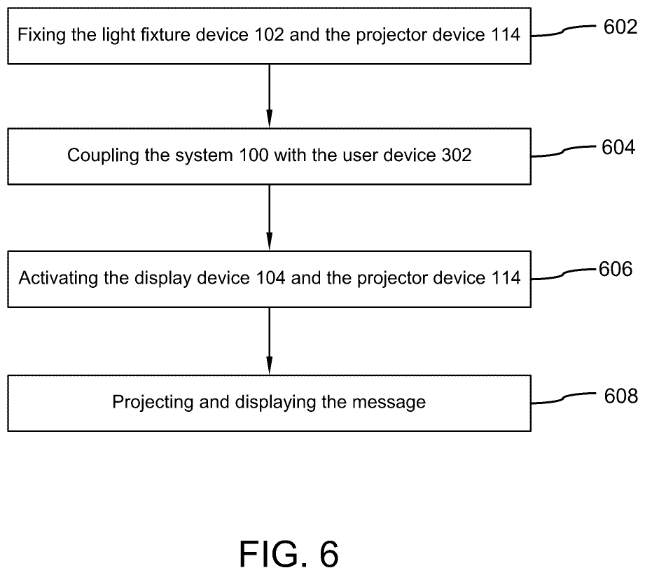

FIG. 6 illustrates a flow chart depicting a process of projection and illumination using the outdoor stake light and electrical projector system of the present invention in accordance with the disclosed structure. Initially, the light fixture device 102 and the projector device 114 are installed into the ground such as in a yard at an appropriate location (Step 602). Then, the system 100 is coupled with the user device 302 for enabling remote operation and configuration of the system (Step 604). Thereafter, the display device 104 is activated using the solar panel 110 and the projector device 114 is activated either using the solar panel 110 or the external electric power (Step 606). Finally, based on the preferences of a user, a message is projected through the projection system 116, and a message which can be the same or different from the projected message is displayed by the display device 104 (Step 608).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “outdoor stake light and electrical projector system”, “projection and messaging system”, “solar-powered outdoor projection and illumination system”, “multi-functional solar lighting and projection device”, and “system” are interchangeable and refer to the outdoor projection and illumination system 100 of the present invention.

Notwithstanding the foregoing, the outdoor projection and illumination system 100 of the present invention can be of any suitable size and configuration as is known in the art without affecting the overall concept of the invention, provided that it accomplishes the above-stated objectives. One of ordinary skill in the art will appreciate that the outdoor projection and illumination system 100 as shown in the FIGS. are for illustrative purposes only, and that many other sizes and shapes of the outdoor projection and illumination system 100 are well within the scope of the present disclosure. Although the dimensions of the outdoor projection and illumination system 100 are important design parameters for user convenience, the outdoor projection and illumination system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An outdoor light display device comprising:
a display device;
a yard stake;
a solar panel; and
a projector;
wherein said display device integrated to a top end of said yard stake;
wherein said yard stake affixable to the ground;
wherein said solar panel slidably attached to said yard stake;
wherein said solar panel absorbs solar energy and converts the solar energy into electrical power;
wherein said electrical power provides electricity to said display device and said projector;
wherein said display device displaying a first display message; and
further wherein said projector displaying a second display message onto a surface.

2. The outdoor light display device of claim 1, wherein said first display message is an LED display.

3. The outdoor light display device of claim 2, wherein said display device rotatable 360 degrees.

4. The outdoor light display device of claim 3, wherein said second display message is an image.

5. The outdoor light display device of claim 4, wherein said surface is selected from the group consisting of a side of a home, a side of a garage, and a garden.

6. The outdoor light display device of claim 5, wherein said projector is pivotally coupled to a first arm and a first hinge bracket for panning said projector, and further wherein said projector is pivotally coupled to a second arm and a second hinge bracket for tilting said projector.

7. The outdoor light display device of claim 6, wherein said projector having a light sensor for autonomous adjustment of a brightness of said projector based on ambient light.

8. An outdoor light display device comprising:
a display device;
a yard stake;
a solar panel;
a projector; and
an internal memory with a plurality of messages;
wherein said display device integrated to a top end of said yard stake;
wherein said yard stake affixable to the ground;
wherein said solar panel slidably attached to said yard stake;
wherein said solar panel absorbs solar energy and converts the solar energy into electrical power;
wherein said electrical power provides electricity to said display device and said projector;
wherein said display device displaying a first display message from said plurality of messages; and
further wherein said projector displaying a second display message from said plurality of messages onto a surface.

9. The outdoor light display device of claim 8, wherein said first display message is an LED display.

10. The outdoor light display device of claim 9, wherein said display device rotatable 360 degrees.

11. The outdoor light display device of claim 10, wherein said second display message is an image.

12. The outdoor light display device of claim 11, wherein said surface is selected from the group consisting of a side of a home, a side of a garage, and a garden.

13. The outdoor light display device of claim 12, wherein said projector is pivotally coupled to a first arm and a first hinge bracket for panning said projector, and further wherein said projector is pivotally coupled to a second arm and a second hinge bracket for tilting said projector.

14. The outdoor light display device of claim 13, wherein said projector having a light sensor for autonomous adjustment of a brightness of said projector based on ambient light.

15. An outdoor light display device comprising:
a display device;
a yard stake;
a solar panel;
a projector;
a mobile application; and
a communication channel;
wherein said display device integrated to a top end of said yard stake;
wherein said yard stake affixable to the ground;
wherein said solar panel attached to said yard stake;
wherein said solar panel absorbs solar energy and converts the solar energy into electrical power;
wherein said electrical power provides electricity to said display device and said projector;
wherein said mobile application sending at least a first display message to said display device through said communication channel;
wherein said display device displaying said at least a first display message;
wherein said mobile application sending at least a second display message to said projector through said communication channel; and
further wherein said projector displaying said at least a second display message.

16. The outdoor light display device of claim 15, wherein said first display message is an LED display.

17. The outdoor light display device of claim 15, wherein said communication channel is a Bluetooth channel.

18. The outdoor light display device of claim 15, wherein said second display message is an image.

19. The outdoor light display device of claim 15, wherein said projector is pivotally coupled to a first arm and a first hinge bracket for panning said projector, and further wherein said projector is pivotally coupled to a second arm and a second hinge bracket for tilting said projector.

20. The outdoor light display device of claim 15, wherein said projector and said display device independently operable.
